(19) United States
(12) Patent Application Publication
(10) Pub. No.: US 2024/0428707 A1
(43) Pub. Date: Dec. 26, 2024

(54) ACUPUNCTURE POINT SIMULATION DEVICE AND METHOD OF USING THE SAME IN EDUCATION TRAINING AND EVALUATION EXAMINATION SYSTEM

(71) Applicant: CHANGHUA CHRISTIAN MEDICAL FOUNDATION CHANGHUA CHRISTIAN HOSPITAL, Changhua City (TW)

(72) Inventors: Sung Yen HUANG, Changhua City (TW); Po Te LIN, Changhua City (TW); Sheng Fei CHUANG, Changhua City (TW); Ting Che CHEN, Changhua City (TW); Sen Yung LIU, Changhua City (TW); Chih Ming LIN, Changhua City (TW); Ming Chih YANG, Changhua City (TW); Jia Ming CHEN, Changhua City (TW); Ya Lun LI, Changhua City (TW)

(21) Appl. No.: 18/746,652

(22) Filed: Jun. 18, 2024

(30) Foreign Application Priority Data
Jun. 21, 2023 (TW) 112123537
Aug. 22, 2023 (TW) 112131457
Aug. 24, 2023 (TW) 112131911

(51) Int. Cl. G09B 23/30; G01L 1/00; G09B 5/00

(52) U.S. Cl. CPC G09B 23/30; G09B 5/00; G01L 1/005

(57) ABSTRACT

The present invention provides an acupuncture point simulation device and a method of using the same in an education training and evaluation examination system. The method comprises the steps of: at least one pressure sensor being electrically connected to a message transceiver module; the module being electrically connected to a first and second message transceiver units; the second unit providing an acupuncture point message to the first unit; a user applying a force to the outer layer of the pressure sensor corresponding to the message, the sensor transmitting a message to the module which sends the message or other message converted by the message; the first unit receiving the message and outputting a first message; and the second unit receiving the first message, performing calculation and comparison, and outputting a second message to the first unit for user identification or reference.

### FIELD OF INVENTION

The present invention relates to medical education training and medical evaluation examination equipment, in particular an acupuncture point simulation device and a method of using the same in an education training and evaluation examination system.

### BACKGROUND OF THE INVENTION

The earliest record of acupuncture and moxibustion in the Chinese nation is the “Huangdi Neijing” published around 100 BC. In the 6th century, it was transmitted to countries such as Korea and Japan, and is now spread all over the world as an alternative medicine. Acupuncture and moxibustion is a simple and effective clinical treatment method. Before the development of Western medicine, acupuncture and Chinese medicine was almost the only way for people to resist disease, prolong life and improve the quality of life, and was able to help patients recover their mind, speech and motor functions. When combined with Western medical treatment, it can shorten the rehabilitation period, increase the ability to live independently, and make progress in balance, walking ability, and quality of life, which is significantly better than those who receive only basic rehabilitation.

Acupuncture and moxibustion therapy is achieved by stimulating acupuncture points to improve symptoms. The principle of acupuncture and moxibustion is based on the theory of meridians in the human body, using needle techniques to stimulate acupuncture points to regulate the functions of the viscera and qi and blood in the body. For different symptoms of patients, relevant acupuncture points are needled, and additional continuous stimulation with an electro-acupuncture device can also be used to enhance the therapeutic effect of acupuncture and moxibustion.

Acupuncture and moxibustion techniques are a very important part of traditional Chinese medicine training. When performing acupuncture point therapy, accurate needle positions and techniques are required to effectively perform acupuncture points in traditional Chinese medicine. In acupuncture therapy, the needling method is divided into three levels: Heaven, Human being, and Earth, according to the depth. When acupuncture reaches each layer, there is a “needle sensation” where the patient feels sour, swollen, and numb, while the doctor performing acupuncture has a sticky needle sensation. During acupuncture, the depth of needling should be decided based on the condition.

Existing acupuncture teaching aids are limited to acupuncture models, anatomical models, etc., where the acupuncture point positions are drawn on the outer surface of a dummy limb. Such models can only provide medical personnel with recognition of acupuncture point locations, and learners cannot practice and verify their learning results.

Further, multiple acupuncture points are distributed on the outer surface of a model body, and a covering may be placed over the outer surface of the model body. Each acupuncture point is further embedded with a first electrical sensing terminal on the model body, and a second electrical sensing terminal is provided on a needle body. The first and second electrical sensing terminals are each connected to a sensor. During education and training, when the needle body contacts an acupuncture point, the first and second electrical sensing terminals become electrically conductive, and the sensor outputs a signal indicating that the learner's operation is correct. However, with such an electrical circuit design, when the learner presses with his finger, it is impossible to know whether the operation is correct or not. In other words, it is not possible to recognize the acupuncture point locations with the fingers.

### SUMMARY OF THE INVENTION

The main purpose of the present invention is to provide an acupuncture point simulation device and a method of using the same in an education training and evaluation examination system having a simulated non-transparent outer layer of human skin, which provides better education and training effects for massage therapists or traditional Chinese medicine practitioners during the learning process of acupuncture and moxibustion medical treatments.

A secondary purpose of the present invention is to provide the acupuncture point simulation device and the method of using the same in the education training and evaluation examination system, which has better education and training effects in recognizing the locations of acupuncture points on the human body.

Another purpose of the present invention is to provide the acupuncture point simulation device and the method of using the same in the education training and evaluation examination system, which has better education and training effects in terms of the deep learning of acupuncture and moxibustion medicine.

Yet another purpose of the present invention is to provide the acupuncture point simulation device and the method of using the same in the education training and evaluation examination system, which has better effects in evaluating and examining the learning results of acupuncture and moxibustion treatment training.

Therefore, in order to accomplish the aforementioned purposes, the present invention provides the acupuncture point simulation device and the method of using the same in the education training and evaluation examination system, comprising the following steps: a step in which at least one pressure sensor is electrically connected to a message transceiver module; a step in which the message transceiver module is electrically connected to a first message transceiver unit; a step in which the first message transceiver unit is electrically connected to a second message transceiver unit; a step in which the second message transceiver unit provides an acupuncture point message to the first message transceiver unit; a step in which a user applies an external force in accordance with the acupuncture point message to the outer layer of the pressure sensor corresponding to the acupuncture point, the pressure sensor transmits a message to the message transceiver module, and the message transceiver module sends the message or other message converted by the message; a step in which the first message transceiver unit receives the message or the other message from the message transceiver module and outputs a first message; and a step in which the second message transceiver unit receives the first message, performs a calculation and comparison, and outputs a second message to the first message transceiver unit for the user identification or reference.

The following are some preferred embodiments of the present invention, which will be further described in detail with reference to the accompanying drawings:

### BRIEF DESCRIPTION OF THE DRAWINGS

FIG. 1 is a partial perspective view of a preferred embodiment (1) of the device of the present invention;

FIG. 2 is a partial exploded perspective view of the preferred embodiment (1) of the device of the present invention;

FIG. 3 is a sectional view taken along the direction 3-3 of FIG. 1;

FIG. 4 is a schematic view of an external force applied to FIG. 3;

FIG. 5 is a schematic view of another external force applied to FIG. 3;

FIG. 6 is a partial perspective view of a preferred embodiment (2) of the device of the present invention; and

FIG. 7 is a schematic flowchart of the implementation steps of the present invention.

### DETAILED DESCRIPTION OF THE PREFERRED EMBODIMENTS

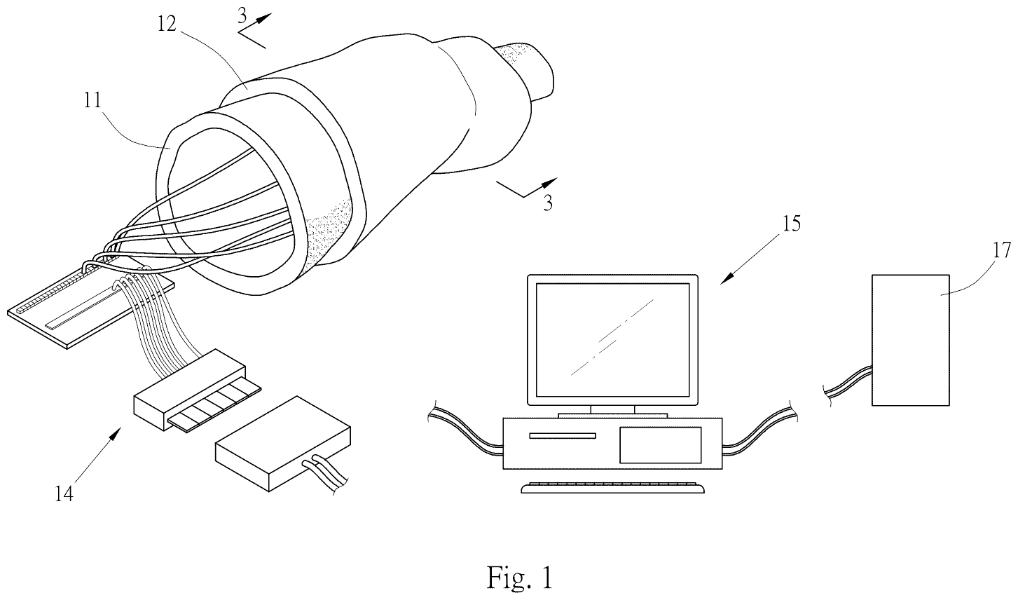

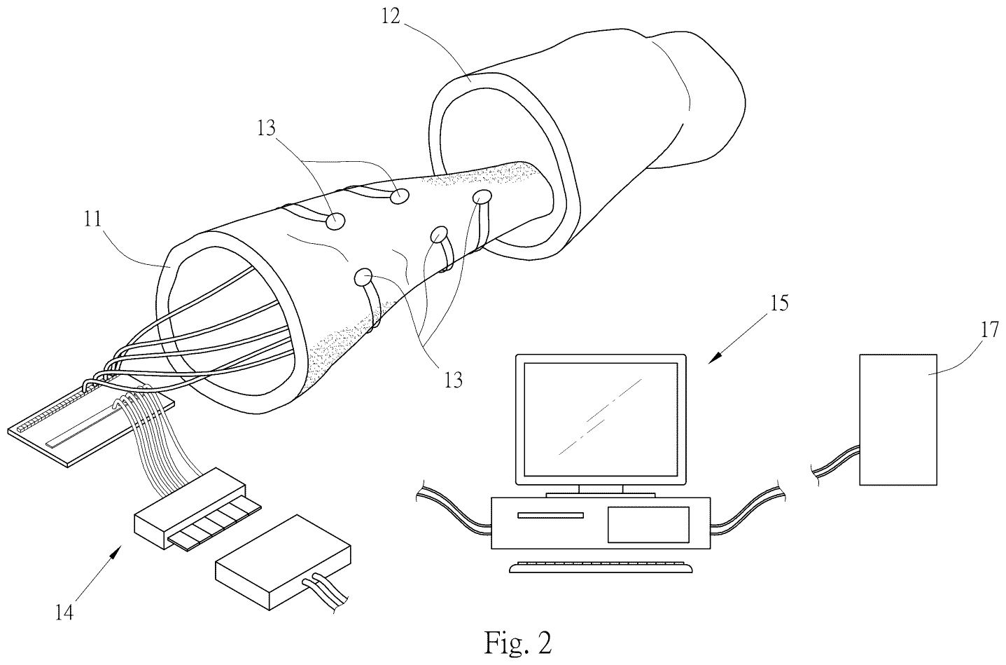

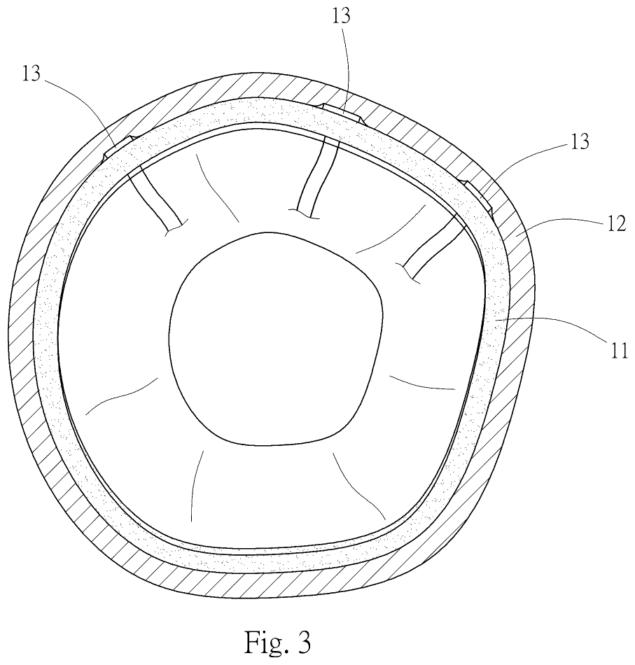

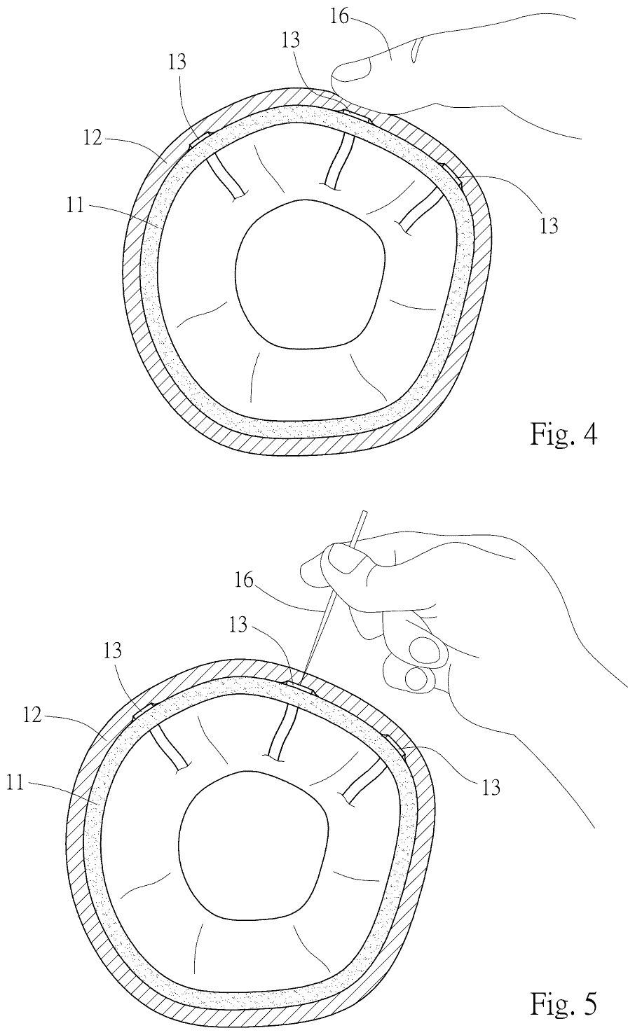

Reference is made to FIGS. 1 to 5. An acupuncture point simulation device and a method of using the same in an education training and evaluation examination system disclosed by the present invention, at least comprising a model body 11, an outer layer 12, at least one pressure sensor 13, a message transceiver module 14, and a first message transceiver unit 15.

The model body 11 simulates the outer shape of a limb of a human body, such as a head, an arm, a leg, or a trunk.

The outer layer 12 is covered on the outer surface of the model body 11, and its material can be a non-transparent silicone or a non-transparent rubber.

The pressure sensor 13 corresponds to an acupuncture point position of the human body on the model body 11 and is positioned between the model body 11 and the outer layer 12. It may be a capacitive, piezoelectric, or piezoresistive sensor.

The message transceiver module 14, such as an electronic circuit module, is electrically connected to the pressure sensor 13 to receive a message transmitted by the pressure sensor 13 and to send the message or other message converted by the message. The message transceiver module 14 can be a single-chip computer with a microcontroller to manage all input and output devices, including hardware and software, which can be used to build various interactive objects and environments.

The first message transceiver unit 15, such as a computer or an electronic circuit module, is electrically connected to the message transceiver module 14 to receive the message or the other message sent from the message transceiver module 14 and to output a display signal. The display signal at least includes one selected from light, sound, vibration, screen, image, or any combination thereof.

Among them, the pressure sensor 13 defines the message as a pressure sensing value, a pressure sensing value within a range, or a combination thereof, based on the attribute, position, or depth of the acupuncture point of the human body. When an external force 16, such as a human finger or a needle body, is applied to the outer layer 12 corresponding to the pressure sensor 13 to generate the message, the pressure sensor 13 then will transmit the message to the message transceiver module 14.

With the design of the non-transparent outer layer 12 resembling human skin in the acupuncture point simulation device disclosed in the present invention, it provides better simulation effects for traditional Chinese medicine practitioners in learning the acupuncture point locations or acupuncture and moxibustion medical treatments on the human body.

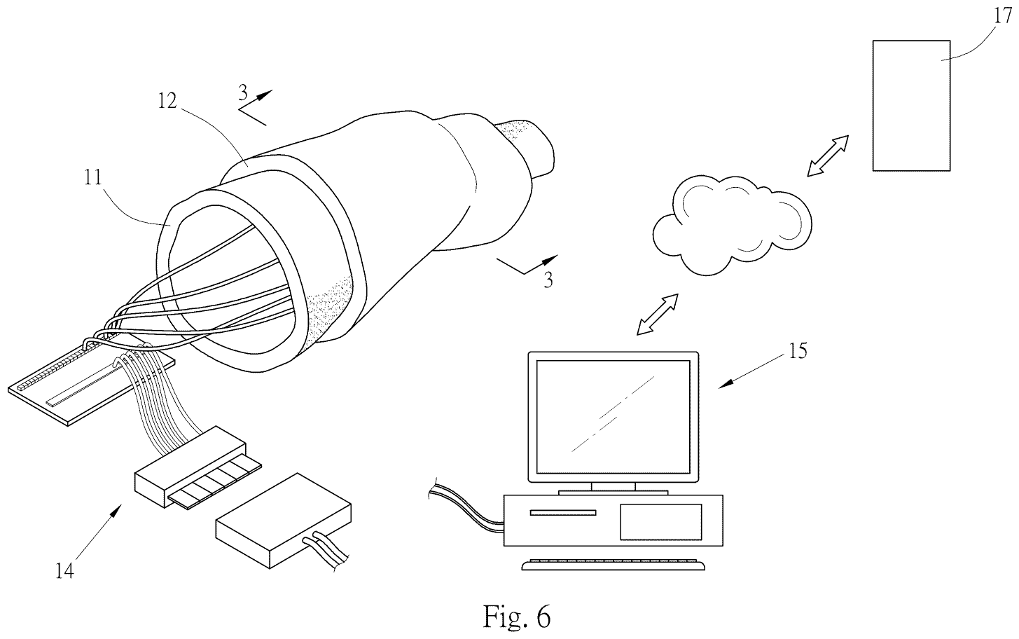

Reference is made to FIGS. 1 and 6. The acupuncture point simulation device of the present invention can also be used for an education training and evaluation examination system, further comprising a second message transceiver unit 17. The first message transceiver unit 15 is further used to be provided with an acupuncture point message for a user to apply the external force 16 to the outer layer of the pressure sensor 13 corresponding to the acupuncture point message, to receive the message or the other message sent from the message transceiver module 14, and to output a first message. The acupuncture point message at least includes a limb part name of a human body and an acupuncture point name.

The second message transceiver unit 17 is electrically connected to the first message transceiver unit 15 for providing the acupuncture point message to the first message transceiver unit 15 and for receiving the first message sent from the first message transceiver unit 15, performing a calculation and comparison, and outputting a second message to the first message transceiver unit 15 for displaying a result message to the user for identification or reference. Wherein the second message transceiver unit 17 includes a database for storing the acupuncture point message and for storing the first message, the second message, or any combination thereof. The second message transceiver unit 17 at least includes a server or an application installed on the first message transceiver unit 15 such as a computer.

The calculation and comparison performed by the second message transceiver unit 17 is used to correspond to the acupuncture point message. It can be an execution program written in a computer programming language such as Python, which is used to perform functions such as identifying the limb shape of the model body 11, identifying the body part of the model body 11, identifying the acupuncture point name, calculating the pressure value, analyzing the pressure value, identifying the correctness of the acupuncture point, determining the time required for completion, and/or determining the number of attempts required for completion, based on the acupuncture point message and the information received from the message transceiver module 14.

The acupuncture point message provided by the second message transceiver unit 17 can be defined/set as an acupuncture point training message or an acupuncture point examination message, to serve as a function of an education training system or an evaluation examination system. Correspondingly, the user can be set as a trainee or an examinee.

For example, the first message transceiver unit 15 can be defined/set as an education message transceiver unit or an examination message transceiver unit, and the second message transceiver unit 17 can be defined/set as a training message transceiver unit or an evaluation message transceiver unit. Correspondingly, the trainee can provide his identity information such as a number and name to the education message transceiver unit to log in to the training message transceiver unit, which then provides an acupuncture point training message to the education message transceiver unit. Correspondingly, the examinee can provide his identity information such as a number and name to the examination message transceiver unit to log in to the evaluation message transceiver unit, which then provides an acupuncture point evaluation message to the examination message transceiver unit.

Reference is again made to FIGS. 1 and 6. In the device of the present invention, the method of electrically connecting the second message transceiver unit 17 to the first message transceiver unit 15 can be through a wired connection, a wireless connection, or an Internet connection. The second message transceiver unit 17 may have Internet functionality to connect to the first message transceiver unit 15 through General Packet Radio Service (GPRS) technology. A web API or web service API application programming interface can be installed between the first message transceiver unit 15 and the second message transceiver unit 17 to manage the communication between the web server and the web browser.

The second message at least includes light, sound, vibration, screen, image, numerical value, table, form, or any combination thereof. The content of the table or form at least includes the acupuncture point name, the pressure value, the pressure value analysis, whether it is the correct acupuncture point, the completion time (from the start of training to the time when the pressure sensor transmits the message), the number of completions, or any combination thereof.

With the design of the non-transparent outer layer 12 resembling human skin and the message communication between the first message transceiver unit 15 and the second message transceiver unit 17 in the acupuncture point simulation device disclosed by the present invention applied to the education training and evaluation examination system, it provides better education training or evaluation examination effects for medical-related practitioners, massage therapists, or traditional Chinese medicine practitioners in learning the acupuncture point locations or acupuncture and moxibustion medical treatments on the human body.

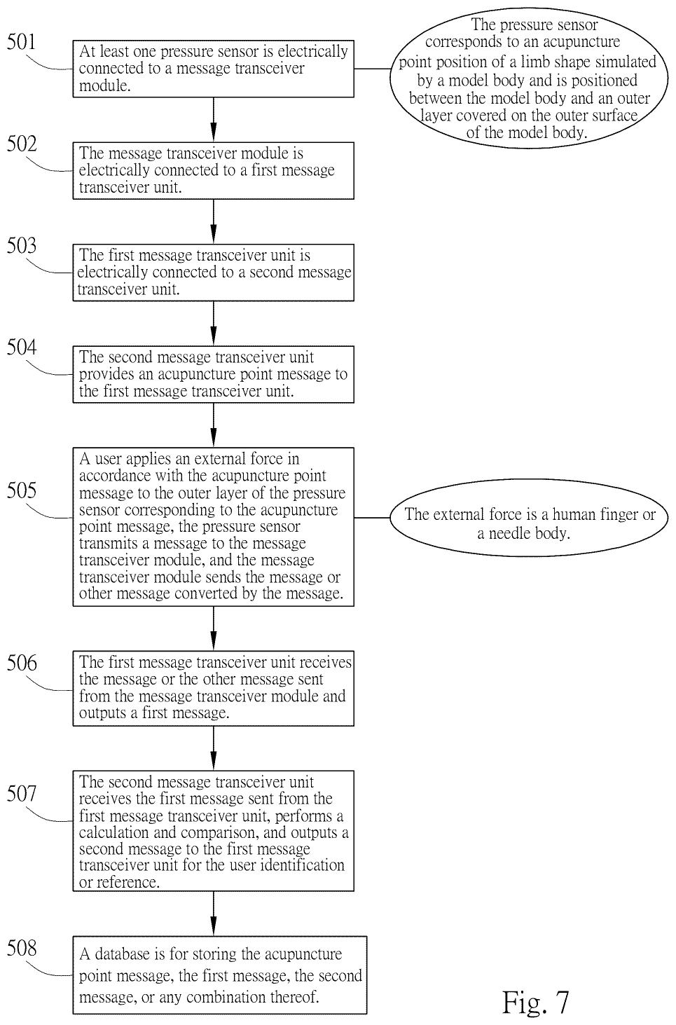

Reference is made to FIG. 7. The acupuncture point simulation device and the method of using the same in the education training and evaluation examination system disclosed by the present invention, the method including the following steps:

Step 501: At least one pressure sensor 13 is electrically connected to a message transceiver module 14, wherein the pressure sensor 13 corresponds to an acupuncture point position of a limb shape simulated by a model body 11 and is positioned between the model body 11 and an outer layer 12 covered on the outer surface of the model body.

Step 502: The message transceiver module 14 is electrically connected to a first message transceiver unit 15.

Step 503: The first message transceiver unit 15 is electrically connected to a second message transceiver unit 17.

Step 504: The second message transceiver unit 17 provides an acupuncture point message to the first message transceiver unit 15.

Step 505: A user applies an external force 16 in accordance with the acupuncture point message to the outer layer 12 of the pressure sensor 13 corresponding to the acupuncture point message, the pressure sensor 13 transmits a message to the message transceiver module 14, and the message transceiver module 14 sends the message or other message converted by the message, wherein the external force 16 is a human finger or a needle body.

Step 506: The first message transceiver unit 15 receives the message or the other message sent from the message transceiver module 14 and outputs a first message.

Step 507: The second message transceiver unit 17 receives the first message sent from the first message transceiver unit 15, performs a calculation and comparison, and outputs a second message to the first message transceiver unit 15 for the user identification or reference.

The aforementioned method of the present invention further includes a step 508 of a database for storing the acupuncture point message, the first message, the second message, or any combination thereof.

The aforementioned method of the present invention further includes a step of querying the database for the stored acupuncture point message, the first message, the second message, or any combination thereof by a date, a human body limb part name, an acupuncture point name, or any combination thereof, and outputting the information by screen display, printing, or any combination thereof.

In the aforementioned method of the present invention, the material of the outer layer 12 is a non-transparent silicone or a non-transparent rubber.

In the aforementioned method of the present invention, the pressure sensor is a capacitive, piezoelectric, or piezoresistive sensor.

In the aforementioned method of the present invention, the first message transceiver unit 15 includes at least one computer, and the second message transceiver unit 17 includes at least a server or an application installed on the computer. The method in which the second message transceiver unit 17 is electrically connected to the first message transceiver unit 15 can be through a wired connection, a wireless connection, or an Internet connection. The second message transceiver unit 17 may have Internet functionality to connect to the first message transceiver unit 15 through General Packet Radio Service (GPRS) technology. A web API or web service API application programming interface can be installed between the first message transceiver unit 15 and the second message transceiver unit 17 to manage the communication between the web server and the web browser.

In the aforementioned method of the present invention, the acupuncture point message at least includes a limb part name of a human body and an acupuncture point name.

In the aforementioned method of the present invention, the second message at least includes light, sound, vibration, screen, image, numerical value, table, form, or any combination thereof. The content of the table or form at least includes the acupuncture point name, the pressure value, the pressure value analysis, whether it is the correct acupuncture point, the completion time (from the start to the time when the pressure sensor transmits the message), the number of completions, or any combination thereof.

In the aforementioned method of the present invention, the acupuncture point message provided by the second message transceiver unit 17 can be defined/set as an acupuncture point training message or an acupuncture point examination message, to serve as a function of an education training system or an evaluation examination system. Correspondingly, the user can be set as a trainee or an examinee.

For example, the first message transceiver unit 15 can be defined/set as an education message transceiver unit or an examination message transceiver unit, and correspondingly the second message transceiver unit 17 can be defined/set as a training message transceiver unit or an evaluation message transceiver unit respectively. Correspondingly, the trainee can provide his identity information such as a number and name to the education message transceiver unit to log in to the training message transceiver unit, which then provides an acupuncture point training message to the education message transceiver unit. Correspondingly, the examinee can provide his identity information such as a number and name to the examination message transceiver unit to log in to the evaluation message transceiver unit, which then provides an acupuncture point evaluation message to the examination message transceiver unit.

What is claimed is:

1. An acupuncture point simulation device, at least comprising:
a model body simulating an outer shape of a limb of a human body;
an outer layer covered on an outer surface of the model body;
at least one pressure sensor being positioned between the model body and the outer layer, corresponding to an acupuncture point position of the human body on the model body;
a message transceiver module being electrically connected to the pressure sensor, for receiving a message transmitted from the pressure sensor and sending the message or other message converted by the message;
a first message transceiver unit being electrically connected to the message transceiver module, for receiving the message or the other message sent from the message transceiver module and outputting a display signal, the display signal at least including being selected from a group consisting of light, sound, vibration, screen, image, and any combination thereof;
wherein the pressure sensor defines the message as being selected from a group consisting of a pressure sensing value, a pressure sensing value within a range, and a combination thereof, based on an attribute, position, or depth of the acupuncture point of the human body, such that when an external force is applied to the outer layer corresponding to the pressure sensor to generate the message, the pressure sensor then transmits the message.

2. The device according to claim 1, further comprising a second message transceiver unit, wherein the first message transceiver unit is further used to be provided with an acupuncture point message for a user to apply the external force to the outer layer of the pressure sensor corresponding to the acupuncture point message and to output a first message, the acupuncture point message at least including a limb part name of a human body and an acupuncture point name; the second message transceiver unit is electrically connected to the first message transceiver unit for providing the acupuncture point message to the first message transceiver unit, and for receiving the first message sent from the first message transceiver unit, performing a calculation and comparison, and outputting a second message to the first message transceiver unit for the user identification or reference, wherein the second message transceiver unit includes a database for storing the acupuncture point message and for storing being selected from a group consisting of the first message, the second message, and a combination thereof.

3. The device according to claim 1, wherein the material of the outer layer is a non-transparent silicone or a non-transparent rubber.

4. The device according to claim 1, wherein the pressure sensor is a capacitive, piezoelectric, or piezoresistive sensor.

5. The device according to claim 2, wherein the first message transceiver unit includes at least one computer and the second message transceiver unit includes at least a server or an application installed on the computer.

6. The device according to claim 1, wherein the acupuncture point message at least includes a limb part name of a human body and an acupuncture point name.

7. The device according to claim 2, wherein the acupuncture point message at least includes a limb part name of a human body and an acupuncture point name.

8. The device according to claim 2, wherein the second message at least includes being selected from a group consisting of light, sound, vibration, screen, image, numerical value, table, form, and any combination thereof, and the content of the table or form at least includes being selected from a group consisting of acupuncture point name, pressure value, pressure value analysis, whether it is the correct acupuncture point, completion time, number of completions, and any combination thereof.

9. The device according to claim 1, wherein the external force is a human finger or a needle body.

10. The device according to claim 2, wherein the external force is a human finger or a needle body.

11. A method of using an acupuncture point simulation device in an education training and evaluation examination system, at least comprising the following steps:
(a) a step in which at least one pressure sensor is electrically connected to a message transceiver module: the pressure sensor corresponding to an acupuncture point position of a limb shape simulated by a model body and being positioned between the model body and an outer layer covered on the outer surface of the model body;
(b) a step in which the message transceiver module is electrically connected to a first message transceiver unit;
(c) a step in which the first message transceiver unit is electrically connected to a second message transceiver unit;
(d) a step in which the second message transceiver unit provides an acupuncture point message to the first message transceiver unit;
(e) a step in which a user applies an external force in accordance with the acupuncture point message to the outer layer of the pressure sensor corresponding to the acupuncture point message, the pressure sensor transmits a message to the message transceiver module, and the message transceiver module sends the message or other message converted by the message: the external force being a human finger or a needle body;
(f) a step in which the first message transceiver unit receives the message or the other message sent from the message transceiver module and outputs a first message; and
(g) a step in which the second message transceiver unit receives the first message sent from the first message transceiver unit, performs a calculation and comparison, and outputs a second message to the first message transceiver unit for the user identification or reference.

12. The method according to claim 11, further comprising a step of a database for storing a message being selected from a group consisting of the acupuncture point message, the first message, the second message, and any combination thereof step.

13. The method according to claim 12, further comprising a step of querying the database for the stored acupuncture point message, first message, second message, or any combination thereof by a date, a human body limb part name, an acupuncture point name, or any combination thereof, and outputting the information by screen display, printing, or a combination thereof.

14. The method according to claim 11, wherein the material of the outer layer is a non-transparent silicone or a non-transparent rubber.

15. The method according to claim 11, wherein the pressure sensor is a capacitive, piezoelectric, or piezoresistive sensor.

16. The method according to claim 11, wherein the first message transceiver unit includes at least one computer, and the second message transceiver unit includes at least a server or an application installed on the computer.

17. The method according to claim 11, wherein the acupuncture point message at least includes a limb part name of a human body and an acupuncture point name.

18. The method according to claim 11, wherein the second message at least includes being selected from a group consisting of light, sound, vibration, screen, image, numerical value, table, form, and any combination thereof, and the content of the table or form at least includes being selected from a group consisting of acupuncture point name, pressure value, pressure value analysis, whether it is the correct acupuncture point, completion time, number of completions, and any combination thereof.

19. The method according to claim 11, wherein the acupuncture point message is defined as an acupuncture point training message or an acupuncture point evaluation message, to serve as an education training system or an evaluation examination system.

20. The method according to claim 19, wherein the first message transceiver unit is defined as an education message transceiver unit or an examination message transceiver unit, corresponding to the second message transceiver unit being defined as a training message transceiver unit or an evaluation message transceiver unit respectively, and comprising the step of:
the user providing his identity information to the first message transceiver unit to log in to the second message transceiver unit, thereby causing the second message transceiver unit to provide the acupuncture point message to the first message transceiver unit.
